(19) United States
(12) Patent Application Publication
(10) Pub. No.: US 2023/0387455 A1
(43) Pub. Date: Nov. 30, 2023

(54) SOLID STATE CELL AND ASSOCIATED MANUFACTURING METHOD

(71) Applicant: FORSCHUNGSZENTRUM JÜLICH GMBH, Jülich (DE)

(72) Inventors: Qianli MA, Jülich (DE); Frank TIETZ, Monschau (DE); Dina FATTAKHOVA-ROHLFING, München (DE); Olivier GUILLON, Jülich (DE)

(21) Appl. No.: 18/034,320

(22) PCT Filed: Oct. 28, 2021
(86) PCT No.: PCT/EP2021/079920

§ 371 Date: Apr. 27, 2023

(30) Foreign Application Priority Data
Nov. 25, 2020 (DE) 10 2020 214 769.8

(51) Int. Cl. H01M 10/0562; H01M 4/134; H01M 10/058; H01M 10/42

(52) U.S. Cl. CPC H01M 10/0562; H01M 4/134; H01M 10/058; H01M 10/4235

(57) ABSTRACT

A solid-state cell, a solid-state battery, and an associated method for producing a solid-state cell is disclosed. A solid-state cell has an electrolyte comprising NaSICON. The solid-state cell comprises a first electrode arranged at a first region of the electrolyte and a second electrode arranged at a second region of the electrolyte. A continuous material layer is arranged at least a third region of the electrolyte on an outer surface of the electrolyte. Alternatively, a chemical composition of the outer surface in the third region of the electrolyte is changed. In this way, the formation of filaments and/or dendrites can be effectively prevented and operation at significantly increased current densities is possible.

The invention relates to a solid-state cell, a solid-state battery and a method for producing a solid-state cell.

Solid-state sodium batteries are regarded as promising energy storage devices, since they have advantages over conventional lithium batteries with organic liquid electrolyte in terms of cost, availability of materials and operational safety. However, dendrite formation occurs in the known solid-state sodium batteries just as in all other alkali metal batteries, such as described in the publication “Recent progress in solid-state electrolytes for alkali-ion batteries” by Cheng Jiang et al, Science Bulletin, Vol. 62, 2017, pp. 1473 to 1490.

Dendrites are electrochemical metal deposits that take place especially at high current densities above 1 mA cm⁻². These typically originate from the electrodes and can result in a short circuit. The batteries can become unusable in this way, as described, for example, in the publication “Solid-state electrolyte materials for sodium batteries: towards practical applications” by F. Tietz and Q. Ma, ChemElectroChem, 2020, Vol. 7, No. 13, pp. 2693 to 2713, and Zhou et al. ACS Central Science, 2017, Vol. 3, No. 1, pp. 52 to 57.

A well-known sodium ion conductor is Na₁₊ₓZr₂(SiO₄)ₓ(PO₄)₃₋ₓ, (0≤x≤3). This compound is also known as NZSP and crystallizes in rhombohedral or monoclinic structures. Such compounds are also called NaSICON after the acronym of “Na Super Ionic Conductor”. Depending on the manufacturing method, an ionic conductivity of NZSP of up to 5*10⁻³ S cm⁻¹ can be achieved, as described for example in DE 10 2015 013 155 A1 and in the publication “Room temperature demonstration of a sodium supertonic conductor with grain conductivity in excess of 0.01 S cm⁻¹ and its primary applications in symmetric battery cells” by Q. Ma et al, Journal of Materials Chemistry A, Vol. 7, 2019, pp. 7766 to 7776.

NaSICON already exhibits improved robustness to dendrite formation compared to other solid-state electrodes. This is described in the publication “Dendrite-tolerant all-solid-state sodium batteries and an important mechanism of metal self-diffusion” by Tsai et al, Journal of Power Sources, Vol. 476, 2020, 228666. Accordingly, the current density at which stable operation of a symmetrical solid-state cell having the structure Na/solid electrolyte/Na is possible is 1 mA cm⁻². However, there consists a need for further increased current densities to enable more efficient, commercially usable applications.

It is the task of the invention to develop a further developed solid-state cell, a further developed solid-state battery and an associated manufacturing process.

The task is solved by the solid-state cell according to claim 1 and by the solid-state battery and the method according to the additional claims. Embodiments are given in the subclaims.

A solid-state cell having an electrolyte which comprises NaSICON serves to solve the task. The solid-state cell comprises a first electrode arranged at a first region of the electrolyte and a second electrode arranged at a second region of the electrolyte. At at least a third region of the electrolyte, a continuous material layer is arranged on an outer surface of the electrolyte. Alternatively, a chemical composition of the outer surface is changed in the third region of the electrolyte.

It has shown that during operation of solid-state cells with an electrolyte containing NaSICON at high current densities, metallic sodium filaments are formed on the outer surface of the electrolyte. Like classical dendrite formation inside the electrolyte, these can lead to a short circuit and thus to the destruction of the cell. Such filaments are formed in particular at current densities above 1 mA cm⁻². Experiments have shown that the formation of such filaments can be prevented by arranging a continuous material layer or by changing the chemical composition of the outer surface of the electrolyte. In other words, a particularly high tolerance to dendrite formation can be achieved. Thus, current densities of more than 2 mA cm⁻² or 3 mA cm⁻² can be achieved in the cell according to the invention. No expensive chemicals or complex technology are required for producing the solid-state cell according to the invention.

A solid-state cell is an electric cell in which the electrodes and electrolyte consist of solid material. Solid-state cells with an electrolyte containing NaSICON may also be referred to as solid-state sodium cells. In particular, the solid-state cell is a battery cell. Typically, the solid-state cell is a cell with solid electrolyte and sodium ions as charge carriers, for example, a sodium-air cell.

NaSICON is an acronym for “Na (Sodium) Super Ionic Conductor” and comprises substances with the formula M^{I}_{1+2w+x-y+z}M^{II}_{w}M^{III}ₓ(Zr, Hf)^{IV}_{2-w-x-y}M^{V}_{y}(SiO₄)_{z}(PO₄)_{3-z}. Here M^{I} is Na. M^{II}, m^{III} and M^{V} are suitable divalent, trivalent and pentavalent metal cations, respectively. For example, M^{II} may be Mg²⁺, Ca²⁺, Sr²⁺, Ba²⁺, Co²⁺ and/or Ni²⁺. For example, M^{II} can be Al³⁺, Ga³⁺, Sc²⁺, La³⁺, Y³⁺, Gd³⁺, Sm³⁺, Lu³⁺, Fe³⁺, and/or Cr³⁺. For example, M^{V} may be V⁵⁺, Nb⁵⁺, and/or Ta⁵⁺.

NaSICON may further comprise substances having the formula Na₁₊ₓZr₂SiₓP₃₋ₓO₁₂, 0<x<3. It may further comprise substances structurally constituted according to the above formula and in which a proportion of Na, Zr and/or Si is replaced by isovalent or equivalent elements. NaSICON are solids. NaSICON exhibit high conductivity for sodium ions and negligible electron conduction. The electrolyte may consist of NaSICON and accordingly may be referred to as NaSICON electrolyte. In particular, the electrolyte is a ceramic electrolyte. The outer surface of the electrolyte of the third region of the electrolyte may be a NaSICON surface, which may be provided with a continuous material layer or changed in chemical composition. In one configuration, the electrolyte comprises or consists of Na_{3,4}Zr_{2,0}(SiO₄)_{2,4}(PO₄)_{0,6}.

The first region, the second region and the third region of the electrolyte are different regions. In one configuration, each is a different side. In particular, each electrode is arranged in the respective region at the surface of the electrolyte. In particular, the regions are located on outer sides of the electrolyte and define portions of the outer surface of the electrolyte. In particular, the first region and the second region are arranged opposite each other. The third region is typically arranged between the electrodes. No electrode is arranged in the third region. The third region may comprise the entire outer surface of the electrolyte that is not covered by the electrodes. In one configuration, the electrolyte is cylindrical and the third region is the circumferential surface of the cylinder. The electrodes may be arranged opposite each other on the end faces of the cylinder. The electrolyte may be in the form of a pellet. Typically, the solid-state cell is constructed in layers such that an electrolyte layer is arranged between two electrode layers. This structure may be repeated.

In the third region of the electrolyte a continuous material layer may be arranged. The material layer provides a physical barrier between the material of the electrolyte and the surrounding atmosphere. In particular, the material layer is arranged such that a contact of the surrounding atmosphere with the electrolyte is prevented. The material layer has no openings or interruptions, so that complete shielding of the electrolyte from the atmosphere is ensured. In particular, the material layer is arranged in all portions of the outer surface of the electrolyte that are not in contact with an electrode. The material layer prevents the formation of sodium filaments, since metallic sodium cannot contact the electrolyte due to the material layer. The material layer may be referred to as a coating.

In one embodiment, the material layer or the changed chemical composition of the outer surface in the third region of the electrolyte serves to change or disrupt the three-phase system of electrode material, surrounding atmosphere, and electrolyte material. The surrounding atmosphere may consist essentially of inert gas and/or noble gas, for example argon. It may include oxygen in proportions of less than 1 ppm, in particular less than 0.5 ppm. Interaction of the electrode material with the atmosphere can be prevented by the solution according to the invention. For example, in conventional solid-state cells, the electrode material sodium may be oxidized by remaining oxygen, which can be prevented by the material layer or the changed chemical composition.

In particular, the material layer is substantially gas-tight. For example, the material layer is impermeable to air and/or oxygen. This is particularly true throughout the whole temperature range in which the solid-state cell can be operated. It may apply in a region from −50° C. to 100° C. In particular, the material layer is waterproof and/or vapor-tight. In particular, the material layer is designed in such a way that per cm² of surface area and at a pressure difference of 10⁵ Pa, less than 1 cm³ of gas loss occurs per year, for example less than 1 cm³ of gas loss in 10 years.

In one configuration, the material layer consists of an inert material. This means a material that does not undergo any chemical reactions under the given conditions. In particular, no chemical reactions take place between the material layer and the electrolyte, the electrode material and/or a surrounding atmosphere. In particular, no chemical reactions take place between the material layer and metallic sodium. In particular, the material layer is fits tightly to the surface of the electrolyte in a planar manner.

In one configuration, the material layer is electrically non-conductive. Typically, it has an electrical conductivity that is less than 10⁻⁴ S/m, in particular less than 10⁻⁸ S/m and, in one example, less than 10⁻¹⁰ S/m.

In one configuration, the material layer comprises or consists of a synthetic resin, particularly an epoxy resin. Synthetic resins, such as epoxy resins, are readily available, easy to handle, and inexpensive. In one configuration, the material layer comprises at least one resin selected from the group consisting of polyethylene resins, polypropylene resins, polybutene resins, polyvinyl chloride resins, polystyrene resins, phenolic resins, epoxy resins, lauxite resins, furan resins. The above resins are well suited to prevent the formation of sodium filaments.

The surface in the third region of the electrolyte may be changed in its chemical composition. This means that the chemical composition of the surface differs from the chemical composition of the electrolyte material. This may be realized, for example, by a punctual, sectional or continuous presence of at least one substance having a composition different from the material of the electrolyte. This substance may be arranged on the surface and/or in the material forming the surface. The surface changed in its chemical composition can be formed in such a way that particles or sections with a deviating chemical composition are arranged on a surface consisting of the electrolyte material. The surface changed in its chemical composition may be such that the material forming the surface includes at least one other substance in addition to the electrolyte material. The change in chemical composition may be performed by performing a chemical reaction on the surface of the electrolyte. For example, a chemical reaction of the electrolyte material with a strong acid or base may occur. The surface changed in its chemical composition may have changed properties compared to a hypothetical, non-changed surface.

The effectiveness of the solution according to the invention can be checked in a simple manner by operating a symmetrical Na/NaSICON/Na cell, for example, cyclically with increasing current density until a short circuit occurs. In this way, in particular on the basis of the current density achieved, the tolerance to the formation of sodium filaments can be determined.

In one embodiment, the chemical composition of the outer surface is changed by having a salt arranged on the surface in the third region of the electrolyte. In particular, the salt is arranged in the form of microparticles, nanoparticles and/or salt crystals. The salt can be arranged, for example, by applying an aqueous salt solution and evaporating or vaporizing the water in the third region. In one configuration, the salt forms a continuous layer on the surface of the electrolyte. However, this is not absolutely necessary to solve the problem. In particular, the salt changes the chemical composition of the surface of the electrolyte so that no sodium filaments form during operation of the solid-state cell.

In a further configuration, the salt is at least one salt arranged from the group comprising LiCl, KBr, MgI, Ca(NO₃)₂, SrSO₄, Ba(HSO₄)₂, FeHPO₄, Ni(HCO₃)₂, Cu(C₂H₃O₂)₂. In one configuration, a salt is arranged that does not contain sodium.

In one embodiment, the salt arranged is a sodium salt. In particular, the sodium salt is selected from the group comprising NaCl, NaBr, NaI, NaNO₃, Na₂SO₄, NaHSO₄, Na₃PO₄, NaH₂PO₄, Na₂HPO₄, Na₂CO₃, NaHCO₃, NaC₂H₃O₂. The above sodium salts can be present individually or in any mixture. Sodium salts are readily available and effectively prevent the formation of filaments.

In one embodiment, the first electrode and/or the second electrode comprises metallic sodium. Thus, the electrode material of at least one electrode comprises metallic sodium. The first electrode and/or the second electrode may be produced from an alloy comprising sodium. The first electrode and/or the second electrode may include Na and Sn, In, K and/or C. In particular, the at least one electrode consists of metallic sodium. Typically, the anode comprises or is produced from sodium.

Sodium is readily available and inexpensive. In addition, metallic sodium allows for a particularly high specific capacity of the solid-state cell. The specific capacity can reach up to 1166 mAh g⁻¹. Furthermore, metallic sodium can achieve a minimum potential of −2.71 V compared to the standard hydrogen electrode.

In one embodiment, the first electrode and the second electrode are configured in the same manner (alike). This means a same shape and/or a same material of the electrodes. In other words, the solid-state cell is a symmetrically constructed cell. For example, both electrodes may be metallic sodium electrodes. Thus, the solid-state cell can have the structure Na—NaSICON—Na. Symmetric cells are often used for simplification to study dendrite formation because they are easier to manufacture than complete cells with anode, cathode and electrolyte and their behavior with respect to dendrite formation is the same as for complete cells. In this way, disadvantages due to inadequacies of the cathode material can be circumvented, so that current densities above 1 mA cm⁻² are possible. For a technical application, however, the complete cells mentioned are particularly relevant. The cathode of such a cell may, for example, be produced from Na₃V₂P₃O₁₂.

In one embodiment, the continuous material layer is a polymer layer. Polymers are electrically non-conductive, do not react with metallic sodium and can be easily applied to the NaSICON surface without gaps. They are inexpensive, easy to process and offer good possibilities for customization of desired properties due to the wide variety of compositions available.

A further aspect of the invention is a solid-state battery. The solid-state battery comprises at least one solid-state cell according to the invention. A solid-state battery is a rechargeable battery in which the electrodes and electrolyte consist of solid material. The solid-state battery may comprise one or more solid-state cells.

A further aspect of the invention is a method of producing a solid-state cell. The solid-state cell comprises an electrolyte comprising NaSICON. The solid-state cell has a first electrode arranged at a first region of the electrolyte and a second electrode arranged at a second region of the electrolyte. The method comprises arranging a continuous material layer on an outer surface in a third region of the electrolyte. Alternatively, the method comprises changing a chemical composition of the outer surface in the third region of the electrolyte. All features, configurations and effects of the solid-state cell described at the outset apply mutatis mutandis to the method and vice versa.

In one configuration, a continuous glass layer is arranged on the outer surface of the electrolyte. Glass exhibits high availability, high hardness, and extremely low electrical conductivity. In one configuration, heating to a temperature above 400° C. may be carried out for fixing the glass to the surface of the electrolyte. The glass layer may comprise one or more components selected from the group comprising SiO₂, Na₂O, CaO, K₂O, SrO, BaO, B₂O₃, P₂O₅, Al₂O₃.

In one configuration, the material is disposed by immersing the electrolyte in a liquid or gel-like material. For example, molten glass or liquid to gel-like polymer may be used. The arrangement of the material layer can be done by coating. In particular, the thickness of the material layer is significantly greater than 1 μm, for example in the range between 0.1 mm and 10 mm.

In particular, the method for producing the solid-state cell is carried out in such a way that the composition of the electrolyte material remains at least substantially unchanged in the sections of the electrolyte that are not located on the outer surface of the electrolyte. In other words, a chemical change in composition occurs at most in the section of the outer surface of the electrolyte. If changes occur in portions of the outer surface of the electrolyte in the first or second region, these portions may be subjected to a mechanical surface treatment such that a surface of the electrolyte material is produced or restored.

In one embodiment, changing the chemical composition of the outer surface is carried out by applying a salt solution containing a salt dissolved in a solvent to the outer surface. The solvent is removed so that salt particles are formed on the outer surface.

The arrangement of the salt on the surface of the electrolyte by means of a dissolved salt is easy to perform. For example, the surface can be moistened with the solvent. Thus, the solid-state cell according to the invention can be produced in a particularly simple and technically effortless manner. In particular, the salt particles are formed in the form of microparticles, nanoparticles and/or salt crystals. The solvent is characterized by the fact that it is suitable for dissolving the salt. For example, the solvent may be water.

As described, salt can change the chemical composition of the surface of the electrolyte such that sodium filaments are not formed. It is possible, but not absolutely necessary, that one or more chemical reactions take place between the salt and the NaSICON.

In one embodiment, the solvent is removed by evaporation or vaporization. In this way, the chemical composition of the surface can be changed in a technically effortless manner. For example, salt crystals can be arranged on the surface in this way in a simple manner.

In one embodiment, the application of the salt solution and/or the removal of the solvent is carried out in such a way that nanoparticles of the salt are formed on the surface. In the case of evaporation or vaporization, this is achieved in particular by suitable adjustment of at least one of the parameters temperature, duration and humidity or vapor pressure of the solvent. A particularly thin layer, which effectively prevents the formation of filaments, can be produced in a simple manner.

In one embodiment, changing the chemical composition of the outer surface is carried out by performing a chemical reaction of the surface with an acid or base. Alternatively or complementarily, a chemical reaction of the surface is performed with at least one substance selected from the group comprising Al₂O₃, ZrO₂, SiO₂, MgO. In particular, the chemical reaction takes place at a temperature above 1000° C. As a result of the chemical reaction, at least one substance different from the material forming the surface may be incorporated into edge regions of the electrolyte.

In particular, a reaction with a strong acid or a strong base may occur. In this case, the reaction can take place at room temperature and is thus technically feasible in a simple manner. In one configuration, a chemical reaction of the surface takes place with at least one base from the group comprising NaOH, LiOH, KOH, Ca(OH)₂, Sr(OH)₂, Ba(OH)₂.

In one configuration, a chemical reaction of the surface occurs with at least one acid selected from the group comprising H₃BO₃ and H₂SiO₃. In one configuration, a chemical reaction of the surface occurs with an acid that is solid at room temperature and/or during the chemical reaction.

In one embodiment, a liquid or pasty material is arranged on the surface of the electrolyte for arranging the continuous material layer on the surface of the electrolyte. The continuous material layer is formed by curing the pasty material.

Curing means solidifying the pasty material into a solid material layer regardless of the underlying mechanism. For example, curing can occur by chemical reaction or physical processes such as evaporation.

In one configuration, arranging a pasty material is accomplished by arranging an amount of the pasty material on at least a portion of the surface and distributing the material over the surface. In particular, a substantially continuous and/or uniform distribution is meant.

In one configuration, the liquid or pasty material includes a polymer configured to cure on the surface of the electrolyte. For example, a gel-like polymer can be used that cures to form a solid polymer layer. For example, furan resin or organic silicate resins that cure at an elevated temperature between 60° C. and 200° C. can be used. Resins are well suited to prevent the formation of sodium filaments. In one configuration, the method comprises raising the temperature to cure the polymer. This configuration allows the solid-state cell of the invention to be produced in a particularly simple and technically effortless manner.

In one embodiment, the liquid or pasty material comprises a synthetic resin, for example an epoxy resin, and a curing agent. For example, the liquid or pasty material includes a curable resin. Curable resins are synthetic resins that can be cured to form thermosets. In particular, reactive resins are meant.

The synthetic resin and the curing agent can be easily mixed together at room temperature and then applied to the surface of the electrolyte. A dense and hard polymer layer is formed during curing, which is well suited to prevent the formation of sodium filaments.

In one embodiment, after changing the chemical composition of the outer surface or arranging the continuous material layer, the following steps take place: optionally, the first region and/or the second region of the electrolyte is subjected to a mechanical surface treatment to remove possible impurities. For example, this is done to free the material of the electrolyte from possible impurities. The first electrode is arranged at the first region of the electrolyte and the second electrode is arranged at the second region of the electrolyte. The arrangement of the two electrodes can be done simultaneously.

In an alternative sequence, an electrode is arranged on the electrolyte and then the changing of chemical composition or the arrangement of the continuous material layer is performed. In particular, this relates to the cathode, for example a Na₃V₂P₃O₁₂ cathode. For example, a Na₃V₂P₃O₁₂ cathode is arranged at one of the first and second regions of a NZSP electrolyte and then the surface of the third region is processed. Subsequently, the sodium anode can be arranged at the other of the first and second regions of the electrolyte.

The mechanical surface treatment can remove applied salt solution, salt particles remaining after solvent removal, and/or arranged material from the first and second regions. Freeing the material of the electrolyte from possible impurities means in particular removing such residues. The salt particles or material layer which have been arranged in the third region are not removed. The mechanical surface treatment can be done, for example, by grinding, polishing and/or cleaning. In particular, the arrangement of the electrodes in a respective first and second region of the electrolyte is performed after the pasty material has cured.

A further aspect of the invention is a use of a solid-state cell according to the invention as an energy storage device which is, in particular, stationary, for example for storing electrical energy from renewable energy sources such as wind or solar energy. A further aspect of the invention is an energy storage device which is, in particular, stationary, for example for storing electrical energy from renewable energy sources such as wind or solar energy, which comprises a solid-state cell according to the invention.

In the following, exemplary embodiments of the invention are also explained in more detail with reference to figures. Features of the exemplary embodiments may be combined individually or in a plurality with the claimed subject matter, unless otherwise indicated. The claimed scopes of protection are not limited to the exemplary embodiments.

The figures show:

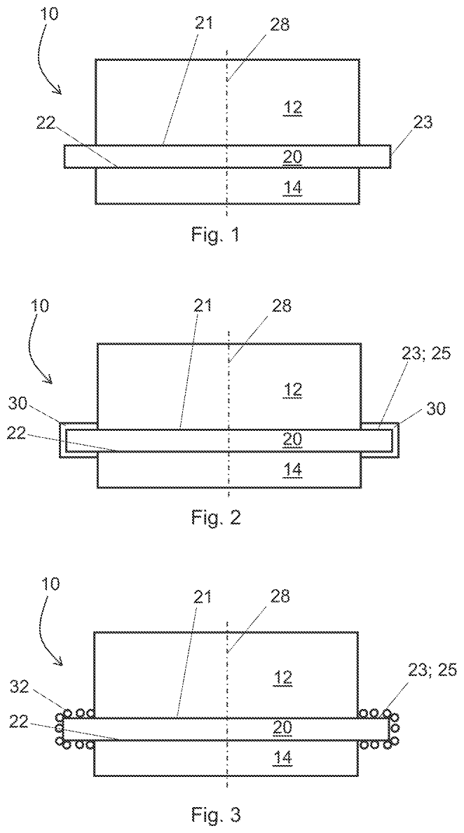

FIG. 1: a schematic sectional drawing of a conventional solid-state cell,

FIG. 2: a first configuration of a solid-state cell according to the invention,

FIG. 3: a second configuration of a solid-state cell according to the invention,

FIG. 4: a third configuration of a solid-state cell according to the invention,

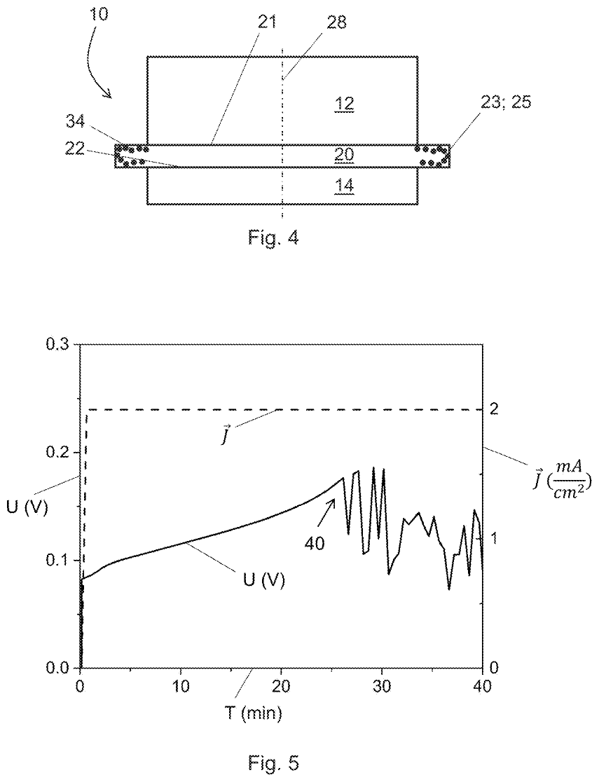

FIG. 5: an operating diagram of a conventional solid-state cell,

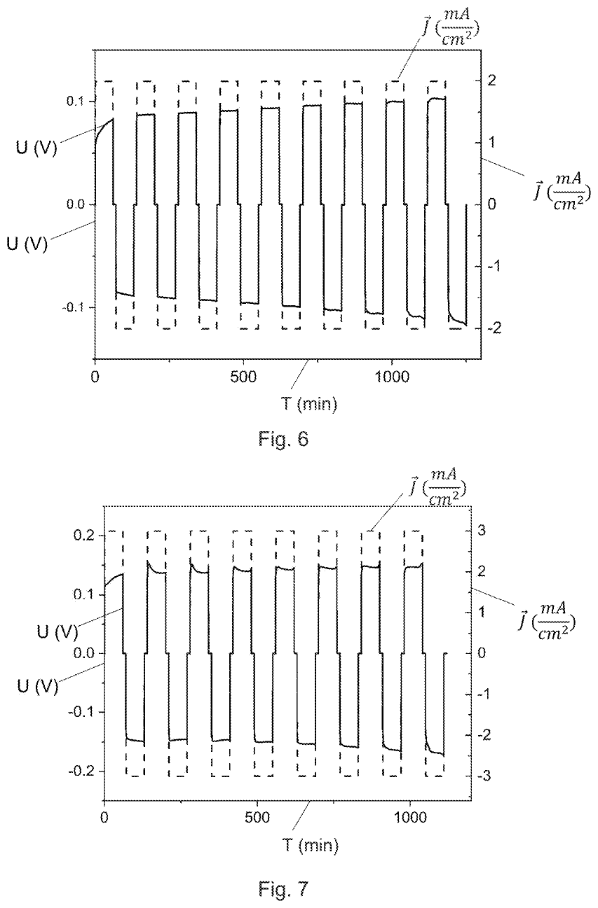

FIG. 6: an operating diagram of a solid-state cell according to the invention, and

FIG. 7: an operating diagram of a further solid-state cell according to the invention.

FIG. 1 shows a conventional solid-state cell having a first electrode 12, a second electrode 14, and an electrolyte 20 arranged therebetween. The electrolyte 20 is configured as a solid electrolyte. In this non-limiting exemplary embodiment, the first electrode 12, the second electrode 14, and the electrolyte 20 are each circular-cylindrical in shape and extend about the central axis 28. The first electrode 12, the second electrode 14, and the electrolyte 20 may take any other shape in deviation therefrom. The first electrode 12 abuts the first region 21 of the electrolyte 20 shown above, which defines a first side of the electrolyte 20. The second electrode abuts the second region 22 of the electrolyte 20 shown below, which defines a second side of the electrolyte 20. The third region 23 of the electrolyte 20 corresponds to the circumferential surface of the circular-cylindrical electrolyte 20. The solid-state cell 10 shown here tends to form filaments or dendrites, so that the current density \vec{J} achievable in operation is limited to at most 1 mA cm⁻² depending on the electrolyte material.

FIGS. 2 to 4 show different configurations of solid-state cells 10 according to the invention. According to a basic structure, each of the solid-state cells 10 comprises a first electrode 12, a second electrode 14 and an electrolyte 20 arranged therebetween. The sizes and size ratios of the electrodes 12, 14 and the electrolyte 20 in FIGS. 2 to 4 are not to scale. The radial extension of the electrodes may be at least substantially equal to or greater than the radial extension of the electrolyte.

The electrolyte 20 is configured as a NaSICON solid electrolyte. The first electrode 12, the second electrode 14, and/or the electrolyte 20 may be circular cylindrical in shape and extend about the central axis 28. The first electrode 12 abuts the first side of the electrolyte 20 shown above. The second electrode 14 abuts the second side of the electrolyte 20 shown below. In the case of a circular cylindrical electrolyte 20, the third side of the electrolyte 20 corresponds to the circumferential surface. The first and/or the second electrode may consist of sodium. The electrodes may be configured alike.

Typically, the electrodes 12, 14 are smaller in cross-section than the electrolyte 20. In other words, the electrolyte 20 protrudes beyond the electrodes 12, 14 horizontally on both sides in the orientation shown here, as shown in the figures. In particular, the cathode is thicker than the anode.

In the configuration shown in FIG. 2, a continuous material layer 30 is arranged in the third region 23 of the electrolyte 20 on the outer surface 25 of the electrolyte 20. This is shown on both sides of all portions of the surface of the electrolyte 20 in the sectional drawing. The material layer 30 is arranged circumferentially and completely covers the surface 25 of the third region 23 of the electrolyte 20. It prevents the formation of dendrites or metallic filaments on the surface 25. In this way, a short circuit is prevented and operation of the solid-state cell at higher current densities is possible. The third region 23 comprises portions facing radially outward, a portion facing in a first axial direction and/or toward the first electrode 12 and a portion facing in the other axial direction and/or toward the second electrode 14. It comprises all regions of the electrolyte 20 that are not contacted by an electrode 12, 14. In one configuration, the material layer 30 contacts the first electrode 12 and/or the second electrode 14 so that the electrolyte 20 is completely spatially separated from the surrounding atmosphere.

In a first example of a solid-state cell 10 constructed according to FIG. 2, a continuous polymer layer is arranged in the surface 25 of the third region 23 of the electrolyte 20. A powder of Na_{3,4}Zr_{2,0}(SiO₄)_{2,4}(PO₄)_{0,6} was produced. The circular cylindrical electrolyte 20, also referred to as a pellet, was produced from the powder. These steps were carried out according to DE 10 2015 013 155 A1 and Journal of Materials Chemistry A, Vol. 7, 2019, pp. 7766 to 7776, which are referred to herein. The pellet has a diameter of 10 mm and a thickness of 2 mm. The relative density of the pellet is >95%.

In producing the solid-state cell 10 according to the invention, the commercially available polymer resin Epoxy 2000 and the associated curing agent from Cloeren Technology GmbH were used. 6.8 g of polymer resin and 3.2 g of curing agent were mixed. The paste obtained was applied evenly to the entire outer surface 25 of the third region 23 of electrolyte 20. This was done using a cotton swab. It should be noted that the first region 21 and the second region 22 of the electrolyte 20 remain free of the paste. If there are impurities in the first region 21 and/or the second region 22, these must be removed, in particular by mechanical surface treatment such as wiping, brushing or grinding. The first region 21 and the second region 22 are exemplary circular sections of the surface of the electrolyte opposite each other. After about 8 hours, the paste had cured to a solid polymer resin. Sodium electrodes were then applied in a glovebox to the opposing regions 21, 22 of electrolyte 20 and pressed on with a force of 1 kN. Operating data of the solid-state cell manufactured in this way are shown in FIG. 6. Operating data of a conventional solid-state cell produced according to the first example but without the described polymer coating are shown in FIG. 5.

In each of the configurations shown in FIGS. 3 and 4, a chemical composition of the outer surface 25 in the third region 23 of the electrolyte 20 is changed. In FIG. 3, this is realized by salt crystals arranged on the surface 25. In particular, these are nanoparticles of a sodium salt. In each case, the third region 23 is formed analogously to FIG. 2.

In a second example of a solid-state cell produced according to FIG. 3, the electrolyte is produced as a NaSICON pellet as in the first example above. A saturated salt solution of 5.0 g NaCl (Merck, 99%) and 10 g distilled water was produced at room temperature. The salt solution was applied evenly to the entire outer surface 25 of the third region 23 of electrolyte 20. This was done using a cotton swab. It should be noted that the first region 21 and the second region 22 of the electrolyte 20 remain free of the salt solution. In the case of possible impurities, it is proceeded as in the first example above. Drying was carried out at 60° C. for 0.5 hours, during which the water evaporated, leaving only NaCl on the surface 25. The sodium electrodes were applied as in the first example above. Operating data for the solid-state cell produced in this way are shown in FIG. 7.

In FIG. 4, the change in chemical composition of the outer surface 25 of the electrolyte 20 is realized through a chemical reaction of the surface 25 with an acid, a base, or a substance from the group comprising Al₂O₃, ZrO₂, SiO₂, MgO that has occurred. The material of the electrolyte 20 has a changed chemical composition at the outer surface 25 compared to the interior. This is schematically shown by the fact that particles of a material 34 different from the material of the electrolyte 20 are present on the outside of the electrolyte 20 in the third region 23. The changed chemical composition of the surface 25 effectively prevents the formation of filaments or dendrites.

The illustration of the particles of salt 32 and the material 34 in FIGS. 3 and 4 is purely schematic and not to scale. It is not excluded that the salt 23 and/or the material 34 forms a layer that is at least partially continuous and/or closed.

The operating diagrams of solid-state cells shown in FIGS. 5 to 7 show the time T in minutes on the horizontal axis, the electric voltage U in volts on the vertical axis shown on the left, and the current density \vec{J} in mA cm⁻² on the vertical axis shown on the right.

FIG. 5 shows the operation of a conventional solid-state cell at a constant current density \vec{J} of 2 mA cm⁻² at a temperature of 25° C. It can be seen that the voltage U increases continuously up to a time T of about 25 minutes. The voltage U reaches a local maximum value of about 0.18 V and then drops steeply. This is followed by an irregular progression of the voltage. The voltage drop after the maximum value is the result of a short circuit 40, which is shown with an arrow in FIG. 5. The formation of Na filaments on the surface of the electrolyte leads to electrical contact between the two electrodes and thus to the behavior shown in FIG. 5. It can be seen that a sustained use of this solid-state cell at a current density \vec{J} of 2 mA cm⁻² is not possible.

FIG. 6 shows the operation of a solid-state cell according to the invention as shown in FIG. 2 over a large number of charge cycles at a temperature of 25° C. The solid-state cell was operated galvanostatically, i.e. with constant current. A moderate force of 1 kN was applied to the electrodes to improve contact between the electrodes and the electrolyte. The operation was carried out at a current density \vec{J} shown in dashed lines, alternating between 2 mA cm⁻² and −2 mA cm⁻². It can be seen that voltages U above 0.08 V and below 0.08 V, respectively, are obtained in a stable manner. It is clear that sustained operation of this solid-state cell is possible at a current density \vec{J} at 2 mA cm⁻².

In a comparable illustration, FIG. 7 shows the galvanostatic operation of a solid-state cell of the invention according to FIG. 3. The operation was carried out over a large number of charge cycles at a temperature of 25° C. The electrodes were subjected to a moderate current density \vec{J} at 2 mA cm⁻², respectively. A moderate force of 1 kN was applied to the electrodes to improve contact between the electrodes and the electrolyte. The dashed current density \vec{J} was alternately 3 mA cm⁻² and 3 mA cm⁻². It can be seen that stable voltages U in the region of 0.15 V and −0.15 V, respectively, are obtained. It is clear that sustained operation of this solid-state cell is possible at a current density \vec{J} at 3 mA cm⁻².

The current density at which stable operation of a symmetrical solid-state cell with the Na/solid electrolyte/Na structure is possible has been at most 1 mA cm⁻² up to now. This value was achieved using a solid electrolyte of Na_{3,4}Zr_{2,0}(SiO₄)_{2,4}(PO₄)_{0,6} (Journal of Power Sources, Vol. 476, 2020, 228666). The use of other solid electrolytes resulted in much lower current densities of 0.3 mA cm⁻² and below. Thanks to the solution according to the invention, the current density can be increased to 2 to 3 mA cm⁻², i.e. by a factor of 2 to 3, by using a solid electrolyte of Na_{3,4}Zr_{2,0}(SiO₄)_{2,4}(PO₄)_{0,6}.

List of Reference Signs

| | |
|---|---|
| solid-state cell | 10 |
| first electrode | 12 |
| second electrode | 14 |
| electrolyte | 20 |
| first region | 21 |
| second region | 22 |
| third region | 23 |
| surface | 25 |
| central axis | 28 |
| material layer | 30 |
| salt | 32 |
| material | 34 |
| voltage | U (V) |
| current density | $\vec{J} ( \frac{mA}{{cm}^{2}} )$ |
| time | T (min) |
| short circuit | 40 |

1. A solid-state cell having an electrolyte which comprises NaSICON, having a first electrode arranged at a first region of the electrolyte and having a second electrode arranged at a second region of the electrolyte, wherein a continuous material layer is arranged at a third region of the electrolyte on an outer surface of the electrolyte, or in that a chemical composition of the outer surface is changed in the third region of the electrolyte.

2. The solid-state cell according to claim 1, wherein the chemical composition of the surface is changed by the fact that a salt is arranged on the surface.

3. The solid-state cell according to claim 2, wherein the sodium salt is in particular selected from the group comprising NaCl, NaBr, NaI, NaNO₃, Na₂SO₄, NaHSO₄, Na₃PO₄, NaH₂PO₄, Na₂HPO₄, Na₂CO₃, NaHCO₃, NaC₂H₃O₂.

4. The solid-state cell according to claim 1, wherein the first electrode and/or the second electrode comprises metallic sodium.

5. The solid-state cell according to claim 1, wherein the first electrode and the second electrode are configured in the same manner.

6. The solid-state cell according to claim 1, wherein the continuous material layer is a polymer layer.

7. (canceled)

8. A method of producing a solid-state cell having an electrolyte which comprises NaSICON, having a first electrode arranged at a first region of the electrolyte and having a second electrode arranged at a second region of the electrolyte comprising:
arranging a continuous material layer on an outer surface in a third region of the electrolyte, or
changing a chemical composition of the outer surface in the third region of the electrolyte.

9. The method according to claim 8, wherein the changing of the chemical composition of the surface is carried out by applying a salt solution containing a salt dissolved in a solvent to the surface and removing the solvent so that salt particles form on the surface.

10. The method according to claim 9, wherein the solvent is removed by evaporation or vaporization.

11. The method according to claim 9, wherein the application of the salt solution and/or the removal of the solvent is carried out in such a way that nanoparticles of the salt are formed on the surface.

12. The method according to claim 8, wherein the changing of the chemical composition of the surface is performed by performing a chemical reaction of the surface with an acid or base and/or by performing a chemical reaction of the surface with at least one substance from the group comprising Al₂O₃, ZrO₂, SiO₂, MgO at a temperature above 1000° C.

13. The method according to claim 8, wherein for arranging the continuous material layer on the surface of the electrolyte, a liquid or pasty material is arranged on the surface of the electrolyte and the continuous material layer is formed by curing the pasty material.

14. The method according to claim 13, wherein the liquid or pasty material comprises a synthetic resin, for example an epoxy resin, and a curing agent.

15. The method according to claim 8, further comprising, after changing the chemical composition of the surface or after arranging the continuous material layer,
optionally, the first region and/or the second region of the electrolyte is subjected to a mechanical surface treatment to remove possible impurities; and
wherein the first electrode is arranged at the first region of the electrolyte and the second electrode is arranged at the second region of the electrolyte.

16. The method according to claim 10, wherein the application of the salt solution and/or the removal of the solvent is carried out in such a way that nanoparticles of the salt are formed on the surface.

17. A solid state battery comprising:
at least one solid-state cell that having an electrolyte which comprises NaSICON, having a first electrode arranged at a first region of the electrolyte and having a second electrode arranged at a second region of the electrolyte, characterized in that a continuous material layer is arranged at a third region of the electrolyte on an outer surface of the electrolyte, or in that a chemical composition of the outer surface is changed in the third region of the electrolyte.
